(19) United States
(12) Patent Application Publication
(10) Pub. No.: US 2025/0058585 A1
(43) Pub. Date: Feb. 20, 2025

(54) IMPROVED BEARING INSTALLATION HUB

(71) Applicant: William Edward SEAWRIGHT, Bramston Beach, Queensland (AU)

(72) Inventors: William Edward SEAWRIGHT, Bramston Beach (AU); Alexander Peter MUZIC, EI Arish (AU)

(73) Assignee: William Edward SEAWRIGHT, Bramston Beach, Queensland (AU)

(21) Appl. No.: 18/722,928

(22) PCT Filed: Dec. 23, 2022
(86) PCT No.: PCT/AU2022/051595

§ 371 Date: Jun. 21, 2024

(30) Foreign Application Priority Data
Dec. 23, 2021 (AU) 2021904253
Mar. 31, 2022 (AU) 2022900829

(51) Int. Cl. B60B 27/00; B60B 27/06; F16C 35/06

(52) U.S. Cl. CPC B60B 27/0078; B60B 27/065; F16C 35/06; F16C 2326/02

(57) ABSTRACT

The invention relates to an improved bearing installation hub for installing a bearing installation to an axle of a trailer, such as a caravan trailer. The improved bearing installation hub includes a first hub body part for connection to the axle, and a second hub body part joined to the first hub body part, for connection to the bearing installation. In this way the first hub body part is connected to the axle, and the bearing installation can be installed on the second hub part, and the bearing installation can be readily installed on the bearing installation hub, or removed therefrom. The invention also includes variations thereon and a method of use.

### FIELD OF THE INVENTION

The present invention relates to an improved bearing installation hub, and in particular to an improved bearing installation hub which enables the bearing installation to be more readily removed or replaced.

### BACKGROUND OF THE INVENTION

The invention is subject of Australian provisional patent application number 2021904253 and Australian provisional patent application number 2022900829 the contents of both of which is incorporated herewith by reference.

When travelling with a trailer at any time, there can be a concern in the back of the mind that the trailer bearings were not checked or serviced after the last trip. Rough road, rocks and extended periods between servicing and lubricating of the bearings can lead to damage. If the bearings fail the axle may become damaged, and this will be a serious problem as removal, replacement or repair of the axle is a difficult job. The worry is therefore exacerbated that neglect to servicing of the bearings installations before a trip could lead to the significant damage, inconvenience and expense of having a damaged axle replaced.

If the bearings fail anywhere, the damage to the axle and difficulties caused is the same, as the vehicle cannot be readily moved. Where bearings fail in a remote location, the vehicle may be a long way away from a mechanic, and as parts may not be readily be available a person may attempt repairs themselves. The arrangement of trailer axle and bearings installations requires extensive use of grease in servicing, and as such is a messy and time-consuming job. Therefore, the job of servicing to check or change the bearings is often neglected, or only attended to infrequently, risking failing bearings and damage to the axle. If the bearings fail and the axle is damaged, what was a dirty and inconvenient job becomes a significant and costly repair.

To change a set of trailer wheel bearings is a protracted process. After removal of the wheel the dust cap is removed, followed by the split pin and nut, allowing removal of the front bearing. There remains a greasy hub which can be removed, often with, but may be separate to, the rear bearing. There follows a seal behind the rear bearing and then using a hammer and punch the front and rear bearing cones are punched out of the hub. At this point the old grease can be cleaned from the components. Once cleaned of the old grease each of the components can be inspected during the process for wear or damage to establish what may need to be replaced.

Reinstallation is a reverse of the process. However, if the bearings are being inspected after a bearing fail, the axle must also be checked to see it has not been bent or damaged. Any damage to the axle is a serious problem and the whole axle will need to be removed, carefully checked, and may need to be replaced, a much more significant mechanical job. Assuming the axle is not damaged, all the components are then greased with fresh grease and replaced by reversing the process. Often the seal surface is worn and can be seen on inspection, but to replace the seal the axle must be removed. In most cases the removal of the axle is not wanted at the time unless absolutely necessary and instead the wear to the seal is noted and the bearings replaced. The damaged seal can be a risk, and should be attended to but often is not, due to the difference in time required between servicing the bearings and the full removal of the axle.

There has long been a desire to be able to replace bearing installation without the need dismantle the whole installation and axle, so that these installations are checked and serviced more often, but also so these installations can be fully replaced without the need to remove an axle. Further there has long been a desire for an easier way to replace bearings, that is easier and quicker to undertake, even in a remote location.

The inventors have developed a surprising new bearing installation hub that uses only a single step to replace bearings, seals, bearing housing, wheel studs and wheel flange plates (bearing installation) to an axle. In the single step, the hub assembly is installed to the axle with a few bolts. The arrangement acts to prevent damage to the axle if the bearings fail and enable the ready replacement of the bearing installation without the need to remove the axle, which is a significant advantage, saving time, money and inconvenience. It is also likely that making the bearing replacement and service job for trailers easier will lead to the serving and replacement occurring more often which will improve safety, and reduce bearing failure, and prevent axle damage in the case of axle failure.

The following describes a non-limiting example of the invention being used with reference to bearings on a trailer or caravan, as a particularly useful application of the invention. The invention may be applicable to any situation where bearings on an axle for trailers are used and it is not intended to limit the invention other than as defined in the claims.

The invention is described with reference to a bearing installation and axle, the inventive hub being a manner to connect these two parts. The bearing installation may include any parts, to connect between the axle and bearings. Additional sections or parts may be included, including isolating the bearings from the hub, but these parts should still be considered as part of the bearing installation as would be understood by the person skilled in the art. Further, the invention is described with the hub connected directly to the axle, but additional parts may be connected to the axle first in alternative forms of the invention, and still is within the scope of the invention. In other words, the hub is designed to connect between the bearing installations and any of its components or additions and an axle, including with any additional attachments to the axle.

For clarity, any prior art referred to herein, does not constitute an admission that the prior art forms part of the common general knowledge, in Australia or elsewhere.

It is an object of the present invention to provide an improved bearing installation hub that at least ameliorates one or more of the aforementioned problems of the prior art. It is a further and separate object of the present invention to provide a method of use of an improved bearing installation hub that at least ameliorates one or more of the aforementioned problems of the prior art.

### DISCLOSURE OF THE INVENTION

Accordingly, the present invention provides an improved bearing installation hub for installing a bearing installation to an axle of a trailer, the improved bearing installation hub including:
a first hub body part for connection to the axle; and
a second hub body part joined to the first hub body part, for connection to the bearing installation;
wherein the first hub body part is connected to the axle, and the bearing installation can be installed on the second hub part, and the bearing installation can be readily installed on the bearing installation hub, or removed therefrom.

Preferably, the improvement is the ability to install the bearing installation more easily. Preferably, the improvement includes that the bearing installation can be installed, removed or replaced more readily. Preferably, the improvement is to provide an installation interface between the bearing of a wheel and the axle to which it is attached. The interface, adaptor or hub used may take any suitable form. Preferably, the improvement is a significant improvement in the ease of installation or servicing of a wheel bearing installed on an axle.

The bearings, or bearing installation for use with the bearing installation hub of the invention may be any suitable bearings. Preferably, the bearings are wheel bearings. Preferably, the bearings are wheel bearings for a caravan. The wheel bearings may be any suitable wheel bearings installed on an axle. The bearings may be any trailer bearings. The wheel bearings may be for fitting to a domestic use trailer or caravan axle. The bearings and bearings installations work in the usual fashion once installed. The use of the inventive hub does not interfere with the bearings in any way so the invention improves the installation and servicing but does not damage the smooth use of the bearings.

The bearings installations may be or include any suitable bearings installations. The bearing installations may include any one or more of: bearings; seals, bearing housing wheel studs and wheel flange plates. The bearing installations may include any suitable components or combination of components to be attached through use of the hub to the axle. Additional components or parts may be included whereby the bearing installation includes other parts, but all the parts connected through to the axle (directly or indirectly) are intended to be included in the invention. The bearing installations may be suitable for any trailer. The bearing installations may be for any trailer axle or similar. The bearing installations may be for a caravan. The bearing installations may be for a boat trailer. The bearing installations may be any suitable bearing installations where the inner race rotates on a stud, mounted in a sealed hub that bolts into or onto the axle (eg standard is the outer race rotates around the axle).

Preferably, the hub protects the axle from damage to the bearing installation. Where in prior installations the seal may become damaged, use of the inventive hub substantially prevents this problem. The hub acts between the bearing and axle to prevent damage thereto and to be readily repaired without the need to replace the axle. This replaces the need to inspect the axle seal in some forms of the invention as the end of the axle is protected by the hub. Preferably, the improvement includes that bearing installation may be replaced more efficiently when compared with the prior art. Preferably, the bearing installation may be more easily installed without the need for full disassembly by use of the hub installed on the axle. Most preferably, the removal and installation of the bearing installation on the hub may be undertaken by a person of ordinary practical skill, and does not need to be an expert mechanic. Preferably, damage to the axle due to bearing failure is substantially prevented, through use of the invention.

In another form of the invention the invention may be used with another form of towed vehicle, or vehicle itself. Most preferably, the invention is used for a wheel bearing of a caravan trailer.

Preferably, the hub is in the form of an intermediary between the axle connection and the bearings of a wheel such that it is easier to install and protects the axle from damage. Preferably, the hub is an improved connection between the axle and bearing installation.

Preferably, the hub is formed of two parts one to connect to the axle and one to connect to the bearing installation to install together for use. Preferably, the bearing installation may be more easily installed through use of holes in the hub and bearing installation and corresponding connecting bolts to connect together. There may be any suitable number of parts. The parts may be separate from one another. Most preferably, the hub is a single piece with different areas or parts that serve different functions. Preferably, the first hub part is in the form of an axle boss and includes a corresponding part to the end of the axle, to fit thereon. The first part or hub may take any suitable form. Preferably, the first hub is installed on the axle during manufacture. In this way the invention and axle may be provided tighter. For example, a caravan may be supplied with the inventive hub installed. Preferably, the hub be retrofitted. In the form where the hub is retrofitted to an axle and fitted on an existing axle in this case at any time. The invention may be provided installed on an axle, or may be provided separately for retrofitting thereon. Preferably, the first hub part, once installed on the axle enables the rest of the bearing installation to be installed, removed or replaced to the axle by fitting the second part of the hub, without the need to remove the axle.

Preferably, the first part includes a receiving part configured to fit an end of an axle therewithin. A range may be provided to suit different axles. The fit is a strong fit suitable for its use on the end of the axle for bearing installation. Preferably, at the other end of the first part the first part is attached or strongly connected to the second hub part. Both the first part and second part correspond to one another and to the connection for the bearing installation. The first part may take any suitable form adapted to receive the axle end on one part. The first part has connections to the second part or is made integral with the second part. The first part may be welded to the axle. The axle may include a narrow end part, in the usual manner and it is to this part that the hub is connected.

Preferably, the second hub part includes parts corresponding to the bearing installation to attach the bearing installation to the remainder of the hub, and by the hub to the axle, ready for use. Preferably, the second hub part includes an aperture corresponding to the part of the bearing installation. Preferably, the second hub includes a generally cylindrical aperture corresponding to the generally cylindrical part of the bearing installation for connection together. The second hub part aperture may take any suitable shape to suit the corresponding part of the bearing installation. Preferably, the first hub part is configured to fit to the axle and the second hub part to a bearing installation for installation together. The installation in use may appear as in FIG. 1 with bearing installation is fitted to second part of the hub, the second part of the hub connected to the first part of the hub, and the axle fitted to the first part of the hub.

The parts of the hub may be manufactured integrally, eg a single hub with a first end and second end, the first end configured to connect to the axle, the second end configured to connect to the bearing installation. In other forms it is possible for the hub to be formed of two parts joined together. In another form of the invention the hub may be manufactured formed part of the axle, or the hub may be connected to the axle during manufacturer.

Preferably, the first hub part is configured to tightly fit on the axle and be carried therewith. The axle boss, hub could be made integral with the axle, or installed during manufacture. The axle end and first hub part may be installed in any suitable manner, including with other parts as required. Preferably, the first hub part includes a part or recess configured to correspond to fit with the end of an axle. Alternatively, the first hub part may be adapted to fit over or around, or as an extension of the axle. Preferably, the first hub part includes a recess or aperture for receipt of the axle, adapted to fit therewithin.

Preferably, second hub part is adapted for installation of the bearing installation. The second hub part may connect to any one or more parts of the bearing installation. Preferably, the second hub part includes a space or recess suitable to receive part of the bearing installation. The second hub part may include a space or recess to receive the inner hub of the bearing installation. Preferably, the second hub part is configured to surround the inner hub part of the bearing installation for installation.

Preferably, the bearing installation is in the form that can be assembled together with the wheel plate and studs forming one end and the bearing housing, through to the bearing inner hub forming the other end whereby the bearing installation can be installed as a unit to the improved bearing installation hub of the invention. Preferably, holes are included in at least on part of the hub and connecting bolts may be used to connect to corresponding holes in the bearing installation. The invention is not limited to this form of bearing installation, any bearing installation may be used with the invention. However, it is a particular useful form of the invention to use with the bearing installation unit (see FIG. 1).

Preferably, the second hub part includes a plate part. The plate part may take any suitable form. Preferably, the plate part includes one or more studs. The number of studs will be adapted to suit the stud holes on the bearings installations to be installed thereon. Any suitable numbers of studs may be included. The size and form of the studs may also be adapted to suit the corresponding bearing installation. Preferably, the studs are suitable to be received in the holes of the bearing installation for connection thereto. The studs may be replaced with any suitable connection to connect with the holes of the bearings.

Most preferably, there will an axle boss (first and second part of the hub) installed on the axle, to which the rest of the bearing installation is installed. Most preferably, the first hub is an axle boss installed on the axle with the second hub part attached for connection of the bearing installation. Most preferably, the second hub is adapted to connect the remainder of the bearing installation to the first hub without contacting the axle. In this way the second hub, and attached bearing installation may be readily removed and replaced without the need to contact or remove the axle. Preferably, use of the invention hub prevents direct contact or risk of damage between the bearing installation and the axle.

Preferably, a range of improved hubs may be provided configured to be suitable to install a particular bearing installation to a particular axle. Therefore, the particular bearing installation used on a particular trailer, can have a suitable inventive hub for attachment to the axle.

Preferably, the improved bearing installation hub is formed of strong steel. The improved bearing installation hub may be made of any suitable materials including composite materials.

Accordingly, the invention also provides a method of use of an improved bearing installation including a first hub part for connection to the axle and a second hub part for connection to the bearing installation the method including the following steps:
a) Installing the first hub part of the improved bearing installation on to the axle of the vehicle (may take place during manufacture); and
b) Installing the bearing installation to the second hub part of the improved bearing installation.

The method may be used with the improved bearing installation hub of the invention in any of its forms or variants. In one form of the invention the hub is provide with the axle. In other forms the hub is retrofitted.

### INDUSTRIAL APPLICABILITY

The improved bearing installation hub of the invention may be manufactured industrially and supplied either direct to a customer, or to a wholesaler or retailer for on-sale. The improved bearing installation hub may be supplied for retro-fit or alternatively supplied preinstalled on an axle.

### BRIEF DESCRIPTION OF THE DRAWINGS

The invention will now be described in connection with a non-limiting preferred embodiment, with reference to the accompanying drawings, in which:

FIG. 1 is a perspective view of a standard bearing installation formed of a wheel plate and studs, bearings, bearing housing and seal (PRIOR ART) and an improved bearing installation hub according to a preferred embodiment of the invention for installation on an axle (PRIOR ART);

FIG. 2 is a perspective view of the standard bearing installation (PRIOR ART) of FIG. 1;

FIG. 3 is a perspective front view of the installation bearing hub of the preferred form of the invention as shown in FIG. 1;

FIG. 4 is a perspective rear view of the installation bearing hub of FIG. 3;

FIG. 5 is a side view of the axle (PRIOR ART) to which the hub of FIG. 1;

FIG. 6 is a schematic cross-sectional side view of the prior art wheel bearing installation of FIG. 1 for fitting to bearing installation hub; and

FIG. 7 is a schematic cross-sectional side view of the installation bearing hub and axle of FIG. 1, and FIG. 6 and FIG. 7 should be viewed side by side to give the view of the whole installation showing the alignment and installation.

### DETAILED DESCRIPTION OF THE INVENTION INCLUDING A BEST MODE

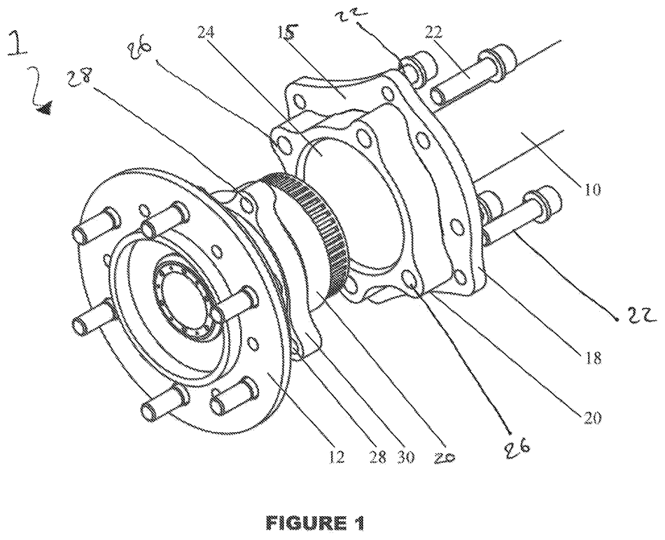

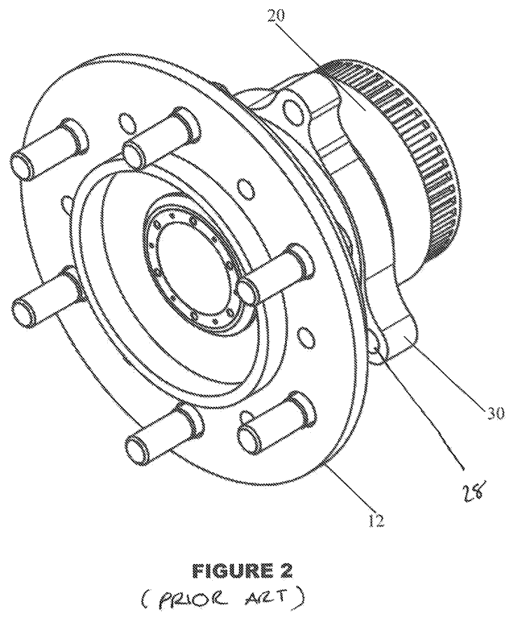

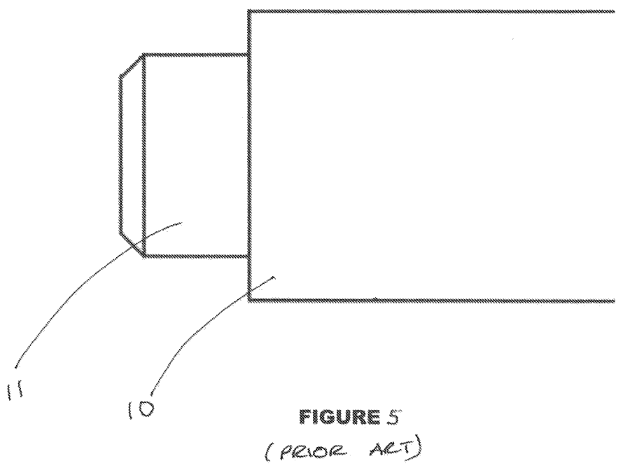

Referring to FIGS. 1 to 7, a preferred embodiment of the invention will be described, and the Figures include the inventive installation hub and prior art bearing installation, together installed on a prior art axle (of a trailer or vehicle, for example to fully illustrate this useful new invention. It is the inventive hub that is new, a new way to install the bearing installation to the existing axle in a single action, whereby this replacement can occur easily in a single step. The invention may be thought of as an adaptor to enable ready bearing installation, and also acts against inadvertent seal damage or other damage to the installation that may occur due to lack of proper replacement or servicing.

Early market research has shown that the ability to more readily replace and install the bearings is a highly desirable and commercial feature that is likely to be desirable to the industry as a whole. It is anticipated that this is an important and significant invention which will make a lasting difference to the way in which bearings are serviced and installed for the future. There are numerous clear advantages improving wheel bearing installation.

The preferred embodiment of the invention will now be described in detail where installation 1 includes axle 10 with end 11, and bearing installation 12 all prior art and all of a standard form with novel bearing installation hub 14. Bearing installation hub 14, is used with brake mount plate 15 to support the installation, both made of a strong cast steel material suitable for use for a trailer. Other strong metals or strong materials may be used instead.

Prior art wheel bearing installation is a standard caravan wheel bearing installation of a known type. The invention can be adapted for a range of wheel and axle combinations, as would be understood. The diameter of the axle end to fit to the inventive hub determining the diameter of the aperture. Standard connecting bolts are used and the size of the holes is determined by the diameter of the connecting bolts. Each of these aspects is standard in the industry and the inventive hub 14 will be supplied with a number of standard diameters for the combinations available.

Axle 10, in the given example, is a conventional axle of a caravan trailer (neither shown). In other forms of the invention bearing installation hub 14 can be provided with axle 10 as an integral part, rather than retrofitted to an existing axle, both forms fall within the scope of the invention. In this case bearing installation hub 14 will be welded or otherwise strongly be fitted to the axle before being provided to the customer or wholesaler. The method of use of the invention is unchanged whether the inventive hub is manufactured with the axle or connected thereto as part of a retrofit.

Bearing installation hub 14 is formed of two sides or parts 16, 18, one side or part for connection to the axle (which may be direct or indirect connection) and one side or part for connection to the bearing installation 12 itself. In the given example a brake mount plate 15 is used to bolt bearing installation hub 14 to bearing installation 12, with the hub being welded to axle 10. Variation may be made to the exact form of connection and installation but the adaptor or hub works in the same way to enable the installation between bearing and axle to replace the conventional method of installation and all the accompanying problems as described elsewhere.

Bearing installation hub 14 with bearing installation part 16 and an axle attachment part 18 are formed as a complete casting, and single adaptor piece. Together the parts of bearing installation hub 14, namely bearing installation part 16 and an axle attachment part 18 form bearing installation hub 14, in the form of an adapted to enable connection between axle and bearing. The invention installation hub is positioned between the prior art bearing and axle, preventing damage, and facilitating replacement. The invention is a significant improvement over the prior art, as it improves the likelihood proper checks will be made, and servicing completed properly.

Axle attachment part 18 is adapted to connect to end 11 of axle 10 and strongly connect together, either through retrofit or during manufacturer. Axle attachment part 18 includes a receiving opening or on to which the end of axle 10 (neither labelled) is fitted with a tight fit in the usual manner. Welding can be used or other forms of attachment as needed. Bearing installation part 16 of bearing installation hub 14 is strongly connected to axle attachment part 18 so as to move therewith in the usual fashion as the caravan trailer is towed along. It is envisaged that a range of inventive hubs can be provided to retrofit to a range of standard axle sizes so that a range of trailers or vehicles can have the benefits of the invention. Once installed bearing installation 12 and axle 10 will be strongly connected together via novel bearing installation hub 14.

Axle attachment part 14 of bearing installation hub 14, has axle connection 18 which fits on the end of axle 10 to firmly attach to axle 10 so they are carried together as the axle rotates in the usual manner.

Bearing 20 of bearing installation 12 is of a standard size and fits within bearing installation part 16 of hub 14 as described further below. Connecting bolts 22 (only some of which are labelled) are used through brake plate 15 and or bearing installation hub to connect and secure the hub and bearing installation together. Once installed the parts fit together in the usual fashion but are tightened and connected through use of connecting bolts 22. Aperture 24 in part 16 is of a suitable diameter and configured to correspond to bearing 20 so as to fit within. The fitting together of the respective parts is illustrated in particular in the side by side Figures of 6 and 7 which when aligned show the connections.

A range of standard sizes of aperture 24 may be provided suitable for a range of sizes of bearings 20 so as to fit.

Connecting bolts 22 15 are configured to match and fit with holes 26 (only some of which are labelled) in bearing installation 14, and then holes 28 (only some of which are labelled) in plate of bearing 30. In this way connecting bolts 22 can be applied from behind bearing installation 14, through holes 26 and then holes 28 in plate of bearing 30. Again, a range of suitable bolts and corresponding hole diameters can be provided to suit different bearing installation requirements.

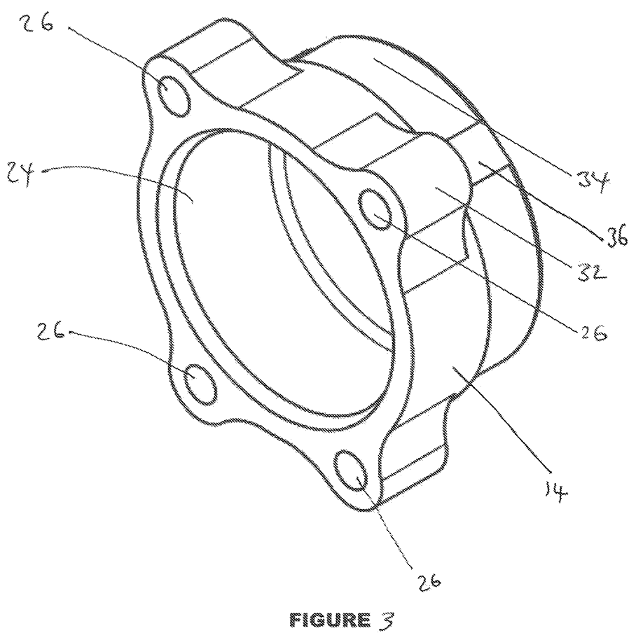

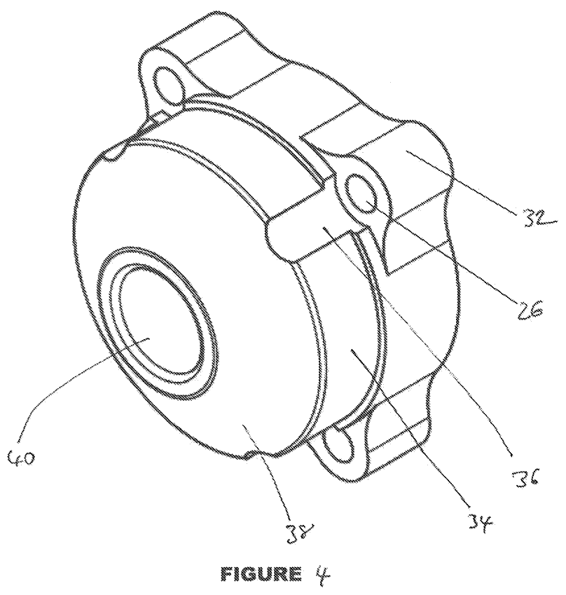

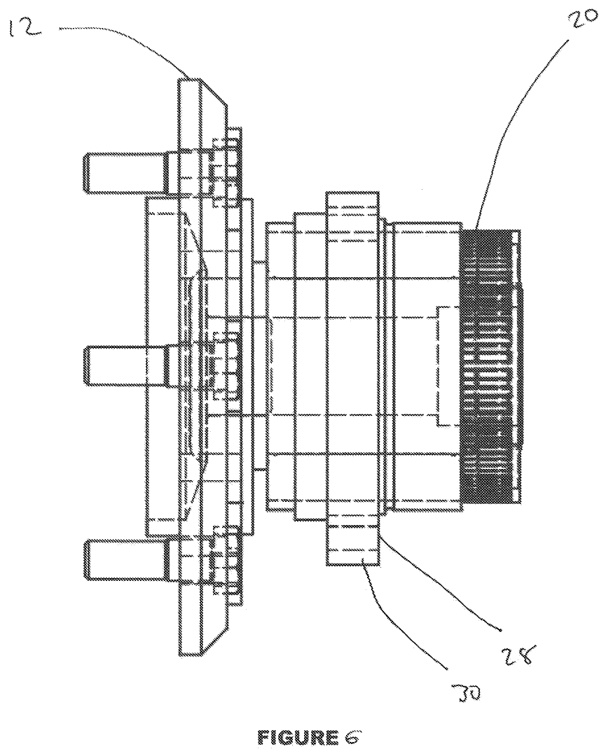

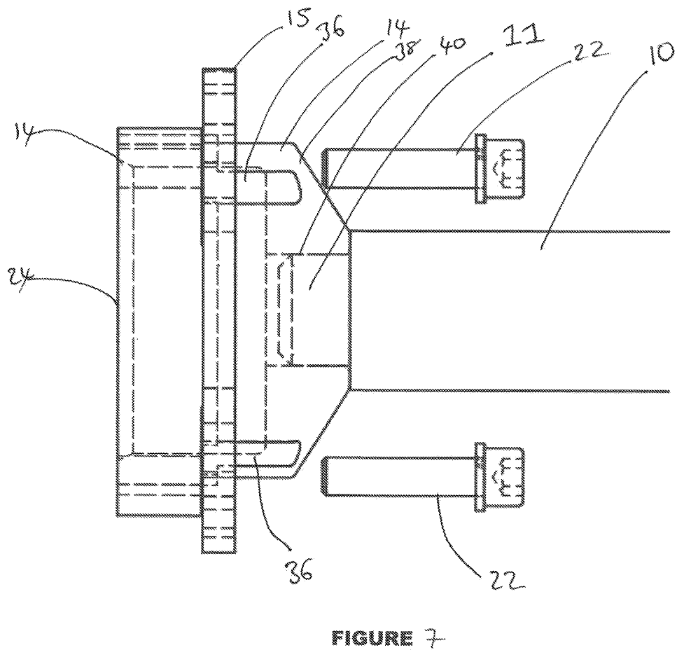

As can be seen in particular in FIGS. 3 and 4, the front and rear or novel bearing installation hub 14 may be seen, with front 32 and rear 34. It is in front 32 that holes 26 are formed for receipt of connecting bolts 22. Groove 36 can be seen in the rear image FIG. 4, to facilitate receipt of connecting bolts 22 from behind through to connect to holes 28 in bearing plate 30. Other forms of connection could be used instead. Rear 34 of hub 14 also includes an angled part 38 leading to aperture 40 sized to receive end 11 of axle 10. The complete arrangement can be seen in FIGS. 6 and 7 when put side by side.

As shown hub 14 has a rear aperture 40 diameter of 35 millimetres, external 47.85 millimetres, and front aperture 24 internal diameter of 90.1 millimetres, and 12 millimetre holes 28 for receipt of corresponding bolts 22. Overall the length of hub 14 is 72 millimetres, 26 millimetres at the front the remainder flat and then angled to the rear. The arrangement is suitable to fit on axle end 1 of 35.01 millimetres of a standard axle.

The current method to change a set of caravan trailer wheel bearings of a known form is a slow, difficult and messy business, hence it is often avoided or not carried out as often as it should. Insufficient servicing can risk failure or fault which can damage not only the bearing but also the axle, and ultimate the wheels and caravan itself. After removal of the wheel of the caravan the dust cap is removed, followed by the split pin and nut, allowing removal of the front bearing like bearing 12 as illustrated (the remainder is not shown for ease of illustration). For prior art arrangements removal of the bearing reveals a hub, which has been greased to assist connection and prevent wear. The hub and the rear bearing may be removed together, and use of a hammer and punch can be used to remove the rear bearing.

The task is hindered by the old grease which needs to be cleaned from all the components, so each of these can be inspected. The inspection cannot be properly carried out with the grease in place as the component needs to be thoroughly checked for damage. Any damaged parts will need to be replaced or there is a risk of further damage and failure, and this may occur when the caravan is being towed on a long trip. In the case of damage in the field, in order that the caravan may be returned to road worthiness the axle must be checked, as any bends or damage to the axle will require replacement. The reality is however these checks are not always completed as often or as thoroughly as they should be done, for safety.

Behind the rear bearing and between it and the axle in prior art arrangement is a seal. This rear seal can become worn or damaged through use, and can only be properly serviced by removal of the rest of the bearing installation, the grease to see if there is damage, and the if there is damage the axle. The removal of the bearing and grease is an unpleasant job, but can be carried out routinely without too much difficulty. However, removal of the axle is another matter and will need to be carried out by a skilled mechanic with the appropriate garage and equipment.

Provided there is no axle damage, once the cleaning and service checking has been completed the bearing and wheel must be put back together, together with replacement of any faulty parts.

For safety it is essential that any damage to the seal and or axle is addressed, but again for the current situation the difficulties and time needed to carry out the task means in often does not happen as it should. It is one of the great many advantages of the subject invention that the bearing installation, can be readily replaced in one or both parts, without the need to remove the axle. Should the installation hub itself be found to be damaged then it can be replaced from the axle and the prior art bearing can readily be checked and if need be replaced and reinstalled on the installation hub in a quick and easy fashion. The saving in terms of time and safety are significant.

The method is similar to the prior art for removal but instead of the need to clean, inspect the seal and regrease the axle for installation the bearing installation is directly installed to the bearing installation hub 14, welded to the axle. The bearing installation can be released by releasing connecting bolts 22 taken apart, cleaned and inspected in one easy step. Replacement is equally easy, as the bearing is installed by lining up the components (FIGS. 6 and 7) and applying connecting bolts through holes 26 and 28 to secure in place. Variations may be made to the form of the invention but this key principle of the very easy installation and replacement remains.

The simplicity of the new design of the subject invention means changes of a bearing installation can be carried out by most practical people, with ease. In an emergency situation this will mean the bearing installation can be changed and reinstalled to the axle in the field, without the need to get to the mechanic if this is not a realistic option due to the location.

Once installed, bearing installation 12 on hub 1 on axle 10 the arrangement is ready for use, as conventional bearing installations. However, the installation can be quickly and easily installed or replaced, without the need to completely remove the axle and all the extra work that this entails.

The invention is a significant advance over the prior art, as it makes a difficult job far easier. It is likely that once the invention is known about that the industry will universally adopt this invention as the standard.

It will be apparent to a person skilled in the art that changes may be made to the embodiment disclosed herein without departing from the spirit and scope of the invention in its various aspects.

REFERENCE SIGNS LIST:

| | |
|---|---|
| 1 | Installation |
| 10 | Axle (PRIOR ART) |
| 11 | Axle end (PRIOR ART) |
| 12 | Bearing installations (PRIOR ART) |
| 14 | Bearing installation hub |
| 15 | Brake mount plate |
| 16 | Bearing installation part of hub |
| 18 | Axle connection part of hub |
| 20 | Bearing |
| 22 | Connecting Bolts |
| 24 | Aperture |
| 26 | Holes in 14 |
| 28 | Holes |
| 30 | Plate of bearing |
| 32 | Front of 14 |
| 34 | Rear of 14 |
| 36 | Groove for 22 |
| 38 | Angled rear or 14 |
| 40 | Aperture in rear of 14 |

1-40. (canceled)

41. An improved bearing installation hub for installing a wheel bearing installation to an axle of a trailer, the improved wheel bearing installation hub including:
a first hub body part for connection to the axle; and
a second hub body part joined to the first hub body part, for connection to the wheel bearing installation;
wherein the first hub body part is connected to the axle, and the wheel bearing installation is installed on the second hub part, and the wheel bearing installation is readily installed on the wheel bearing installation hub, or removed therefrom, and
further wherein the hub is provided installed on an axle, as an integral unit installed on the axle during manufacture, and the hub substantially protects the axle from damage as the hub acts between the bearing and axle to prevent damage thereto, and further wherein a range of hubs may be provided to suit different axles.

42. The improved bearing installation hub of claim 41, wherein the improvement is to provide an installation interface between the bearing of a wheel and the axle to which it is attached.

43. The improved bearing installation hub of claim 41, wherein the bearing installation includes any one or more of: bearings; seals, bearing housing wheel studs and wheel flange plates.

44. The improved bearing installation hub of claim 41, wherein the bearing installations are of a caravan trailer.

45. The improved bearing installation hub of claim 41, wherein the bearing installation is more easily installed through use of holes in the hub and bearing installation and corresponding connecting bolts to connect together.

46. The improved bearing installation hub of claim 41, wherein the hub is in the form of an intermediary between the axle connection and the bearings of a wheel such that it is easier to install and protects the axle from damage.

47. The improved bearing installation hub of claim 41, wherein the hub is an improved connection between the axle and bearing installation.

48. The improved bearing installation hub of claim 41, wherein the hub is formed of two parts one to connect to the axle and one to connect to the bearing installation to install together for use.

49. The improved bearing installation hub according of claim 41, wherein the first hub part, once installed on the axle enables the rest of the bearing installation to be installed, removed or replaced to the axle by fitting the second part of the hub, without the need to remove the axle.

50. The improved bearing installation hub of claim 41, wherein the first part includes a receiving part configured to fit an end of an axle therewithin.

51. The improved bearing installation hub of claim 41, wherein the first part and second part correspond to one another and to the connection for the bearing installation.

52. The improved bearing installation hub claim 41, wherein the first part has connections to the second part or is made integral with the second part.

53. The improved bearing installation hub of claim 41, wherein the second hub part includes parts corresponding to the bearing installation to attach the bearing installation to the remainder of the hub, and by the hub to the axle, ready for use.

54. The improved bearing installation hub of claim 41, wherein the second hub part includes an aperture corresponding to the part of the bearing installation.

55. The improved bearing installation hub of claim 41, wherein the second hub includes a generally cylindrical aperture corresponding to the generally cylindrical part of the bearing installation for connection together.

56. The improved bearing installation hub of claim 41, wherein the first hub part is configured to fit to the axle and the second hub part to a bearing installation for installation together.

57. The improved bearing installation hub of claim 41, wherein the second hub part is adapted for installation of the bearing installation.

58. The improved bearing installation hub of claim 41, wherein the bearing installation is in the form that can be assembled together with the wheel plate and studs forming one end and the bearing housing, through to the bearing inner hub, forming the other end, whereby the bearing installation can be installed as a unit to the improved bearing installation hub.

59. The improved bearing installation hub of claim 41, wherein there will an axle boss (first and second part of the hub) installed on the axle, to which the rest of the bearing installation is installed.

60. An improved bearing installation hub for installing a bearing installation to an axle of a trailer, the improved bearing installation hub including:
a first hub body part for connection to the axle; and
a second hub body part joined to the first hub body part, for connection to the bearing installation;
wherein the first hub body part is connected to the axle, and the bearing installation can be installed on the second hub part, and the bearing installation can be readily installed on the bearing installation hub, or removed therefrom.
